(19) United States
(12) Patent Application Publication
(10) Pub. No.: US 2021/0067647 A1
(43) Pub. Date: Mar. 4, 2021

(54) IMAGE FORMING APPARATUS AND PROGRAM

(71) Applicant: Konica Minolta, Inc., Tokyo (JP)

(72) Inventors: Akinori KIMATA, Toyokawa-shi (JP); Yukinobu IGUCHI, Hamamatsu-shi (JP); Satoru SASAKI, Toyokawa-shi (JP); Kenichi HAYASHI, Anjo-shi (JP); Shiro UMEDA, Toyokawa-shi (JP); Noriyuki JINBO, Hamamatsu-shi (JP)

(21) Appl. No.: 17/004,217

(22) Filed: Aug. 27, 2020

(30) Foreign Application Priority Data
Aug. 29, 2019 (JP) 2019-156780

(51) Int. Cl. H04N 1/00

(52) U.S. Cl. CPC H04N 1/00724; H04N 1/00594; H04N 1/00737

(57) ABSTRACT

An image forming apparatus includes: a transport device that transports a sheet placed on a sheet holding member; a detector that detects one type from among a first number of types as a type of the sheet transported by the transport device; a display that displays the type of the sheet placed on the sheet holding member; and an input device that accepts an instruction related to a display pattern of the type of the sheet, wherein the input device accepts an instruction to select the display pattern from a first display pattern in which the type of the sheet is selected from among the first number of types, and a second display pattern in which the type of the sheet is selected from a second number of types, and the display displays the type that is a result of the detection by the detector.

### CROSS REFERENCE TO RELATED APPLICATIONS

The present invention claims priority under 35 U.S.C. § 119 to Japanese Application No. 2019-156780, filed on Aug. 29, 2019, the entire content of which is incorporated herein by reference.

### BACKGROUND

### Technological Field

The present disclosure relates to the display of the type of paper transported in an image forming apparatus.

### Description of the Related Art

For conventional image forming apparatuses such as multifunction peripherals (MFPs), various proposals have been made on the detection of the type of paper. For example, JP 2000-356507 A discloses a technique related to the detection of recycled paper. JP 2007-24837 A discloses a technique related to the accurate detection of the basis weight of paper. JP 10-310284 A discloses a technique related to the display of the type of paper detected.

Displaying the type of paper detected in an image forming apparatus can provide useful information to the user, but can cause various problems. For example, different detection results may be derived on the same type of paper in different models of image forming apparatuses. In this case, on the same type of paper, the user will be presented with the display of different detection results on one image forming apparatus and another image forming apparatus, and may feel strange.

Further, if the name of a type of paper used as the result of detection on an image forming apparatus is different from a name that the user expects to be displayed on this type of paper, the user may be confused. More specifically, a case is expected where the user has assigned the name “plain paper” to paper of a type that the user uses on a daily basis. In this case, if an image forming apparatus detects paper of this type as a type other than the “plain paper” and displays the name of the detected type, the user may feel strange even when the result of the detection is correct.

### SUMMARY

The present disclosure has been invented in view of these circumstances, and its object is to provide a technique for displaying the result of detection of the type of paper in an image forming apparatus in a mode preferable for the user.

To achieve the abovementioned object, according to an aspect of the present invention, an image forming apparatus reflecting one aspect of the present invention comprises: a transport device that transports a sheet placed on a sheet holding member; a detector that detects one type from among a first number of types as a type of the sheet transported by the transport device; a display that displays the type of the sheet placed on the sheet holding member; and an input device that accepts an instruction related to a display pattern of the type of the sheet, wherein the input device accepts an instruction to select the display pattern from a first display pattern in which the type of the sheet placed on the sheet holding member is selected from among the first number of types, and a second display pattern in which the type of the sheet placed on the sheet holding member is selected from a second number of types fewer than the first number, and the display displays the type that is a result of the detection by the detector according to the instruction accepted by the input device.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram showing an external appearance of an image forming apparatus that is an embodiment of an image forming apparatus of the present disclosure;

FIG. 2 is a diagram schematically showing an internal configuration of the image forming apparatus;

FIG. 3 is a diagram showing a hardware configuration of the image forming apparatus;

FIG. 4 is a diagram for explaining a configuration of a sensor unit;

FIG. 5 is an enlarged view of an optical detector in the sensor unit;

FIG. 6 is an enlarged view of an ultrasonic detector in the sensor unit;

FIG. 7 is a diagram showing a functional configuration of the image forming apparatus;

FIG. 8 is a diagram showing an example of a correspondence relationship between a signal from the sensor unit and the result of detection of the type of recording paper in the image forming apparatus;

FIG. 9 is a diagram for explaining the details of process control according to the type of the recording paper in the image forming apparatus;

FIG. 10 is a diagram for explaining a correspondence relationship between the result of detection of the type of the recording paper and display information of the type by a notification device;

FIG. 11 is a flowchart of a first example of a process performed to display the type of the recording paper in the image forming apparatus;

FIG. 12 is a flowchart of a second example of a process performed to display the type of the recording paper in the image forming apparatus;

FIG. 13 is a diagram showing a specific example of display information on an operating panel;

FIG. 14 is a diagram showing a specific example of display information on the operating panel;

FIG. 15 is a diagram showing a specific example of display information on the operating panel;

FIG. 16 is a diagram showing a specific example of display information on the operating panel; and

FIG. 17 is a diagram showing a specific example of display information on the operating panel.

### DETAILED DESCRIPTION OF EMBODIMENTS

Hereinafter, an image forming apparatus of one or more embodiments of the present invention will be described with reference to the drawings. However, the scope of the invention is not limited to the disclosed embodiments. In the following descriptions, the same reference numerals are assigned to the same parts and components. Their names and functions are also the same. Thus, these will not be described repeatedly.

### 1. Schematic Configuration of Image Forming Apparatus

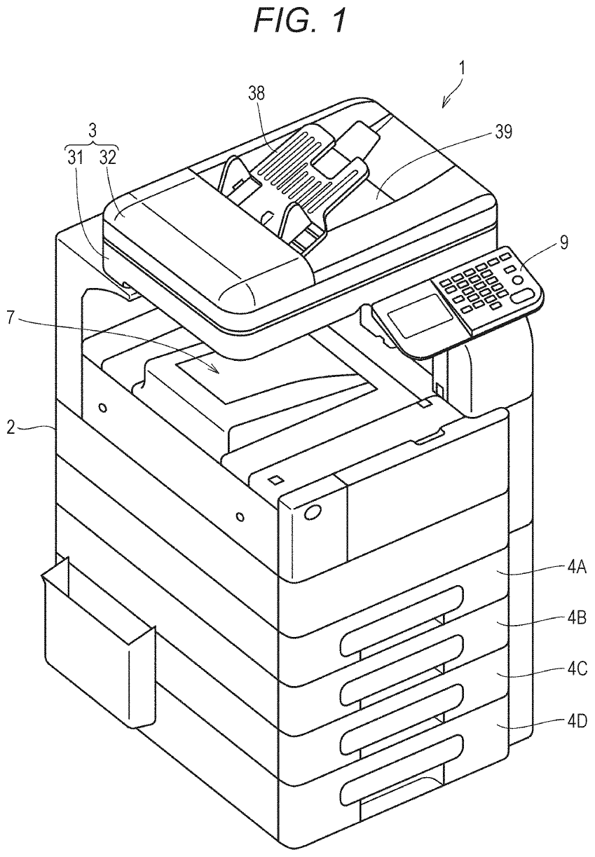

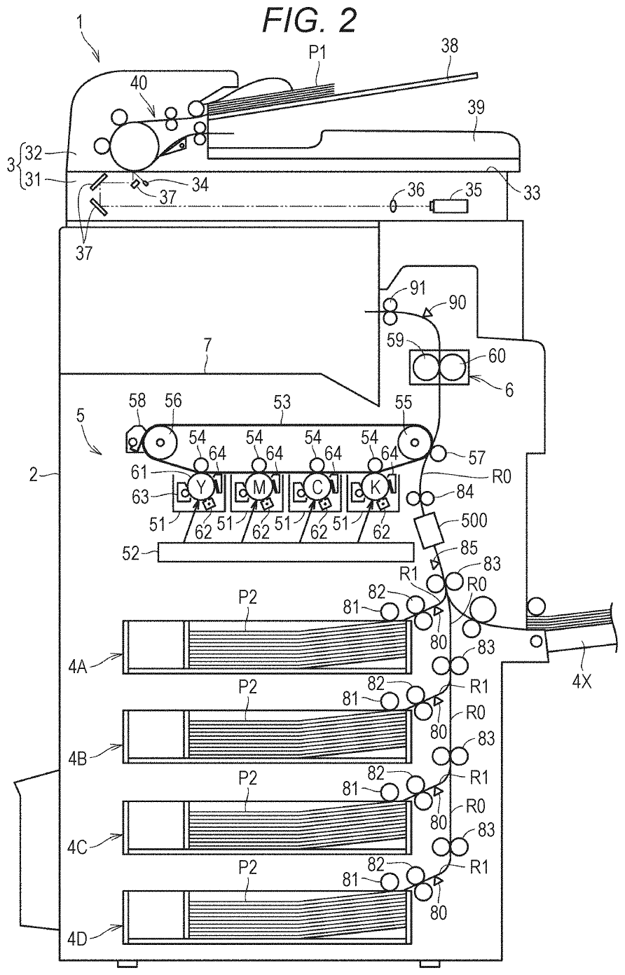

FIG. 1 is a diagram showing an external appearance of an image forming apparatus 1 that is an embodiment of the image forming apparatus of the present disclosure. FIG. 2 is a diagram schematically showing an internal configuration of the image forming apparatus 1.

As shown in FIGS. 1 and 2, the image forming apparatus 1 includes an image reader 3 that reads an image from an original P1, paper cassettes 4A to 4D that store recording paper P2 on which an image is formed, a transfer section 5 that transfers a toner image to the recording paper P2, a fuser 6 that fuses a toner image transferred by the transfer section 5 to the recording paper P2, a paper output tray 7 to which the recording paper P2 on which an image has been formed by being fused by the fuser 6 is ejected, and an operating panel 9 that accepts an operation to the image forming apparatus 1. In an apparatus body 2 of the image forming apparatus 1, the image reader 3 is provided in an upper portion and the transfer section 5 is provided in a lower portion.

As described above, the image forming apparatus 1 includes the four paper cassettes 4A to 4D. The recording paper P is an example of a sheet. Each of the paper cassettes 4A to 4D storing the recording paper P is an example of a sheet holding member on which sheets are placed. In the present specification, the paper cassettes 4A to 4D are sometimes referred to as the “paper cassettes 4” when a characteristic common to the paper cassettes 4A to 4D is mentioned.

In the image forming apparatus 1, the paper output tray 7 is provided above the transfer section 5 in order to receive the recording paper P2 ejected on which an image has been recorded by the transfer section 5 and the fuser 6. The paper cassettes 4 are provided below the transfer section 5. The paper cassettes 4 can be inserted into and removed from the apparatus body 2. In the image forming apparatus 1, the recording paper P2 stored in the paper cassettes 4 is fed to the inside of the apparatus body 2. The recording paper P2 is transported upward, thereby being sent to the transfer section 5 disposed above the paper cassettes 4, and an image is transferred thereto by the transfer section 5. The fuser 6 fuses the image transferred to the recording paper P2. The recording paper P2 that has been processed by the fuser 6 is ejected to the paper output tray 7. The paper output tray 7 is provided in a space (recessed space) between the image reader 3 and the transfer section 5.

The image reader 3 includes a scanner 31 that reads an image from an original P1, and an automatic document feeder (ADF) 32 that is provided above the scanner 31 and transports originals P1 one by one to the scanner 31. The operating panel 9 is provided on the front side of the apparatus body 2. The user operates keys while looking at a display screen or the like of the operating panel 9, thereby being able to perform a setting operation on a function selected from among various functions of the image forming apparatus 1, or to instruct the image forming apparatus 1 to execute a task.

With reference to FIG. 2, an internal configuration of the apparatus body 2 will be described. The scanner 31 of the image reader 3 includes a document table 33 having a platen glass (not shown) on its top side, a light source 34 that illuminates an original P1 with light, an image sensor 35 that photoelectrically converts the light reflected from the original P1 into image data, an imaging lens 36 that images the reflected light on the image sensor 35, and a mirror group 37 that sequentially reflects the light reflected from the original P1 to make it enter the imaging lens 36.

The light source 34, the image sensor 35, the imaging lens 36, and the mirror group 37 are provided inside the document table 33. The light source 34 and the mirror group 37 are configured to be movable in the left-and-right direction with respect to the document table 33.

The ADF 32 is provided on the top side of the scanner 31. The ADF 32 is openable and closable with respect to the document table 33, and includes a document placement tray 38 and a document ejection tray 39. The ADF 32 covers an original P1 on the platen glass (not shown) of the document table 33, thereby being able to bring the original P1 into close contact with the platen glass (not shown).

When the image reader 3 reads an original P1 on the platen glass (not shown) of the document table 33, the light source 34 moving toward the right (in a sub-scanning direction) illuminates the original P1 with light. The reflected light reflected from the original P1 is sequentially reflected off the mirror group 37 that moves toward the right like the light source 34, entering the imaging lens 36, and being imaged on the image sensor 35. The image sensor 35 performs photoelectric conversion pixel by pixel according to the intensity of the incident light, generating an image signal (RGB signal) corresponding to the image of the original P1.

On the other hand, when the image sensor 35 reads an original P1 placed on the document placement tray 38, the original P1 is transported to a read position by a document transport mechanism 40 including a plurality of rollers and others. The light source 34 and the mirror group 37 of the scanner 31 are fixed at predetermined positions inside the document table 33. The light source 34 illuminates a portion of the original P1 at the reading position with light, and the reflected light is imaged on the image sensor 35 via the mirror group 37 and the imaging lens 36 of the scanner 31. After that, the image sensor 35 converts the reflected light into an image signal (RGB signal) corresponding to the image of the original P1. After that, the original P1 is ejected to the document ejection tray 39.

The transfer section 5 that transfers a toner image to the recording paper P2 includes image forming units 51 that generate toner images of yellow (Y), magenta (M), cyan (C), and key tone (K) colors, an exposure unit 52 provided below the image forming units 51, an intermediate transfer belt 53 that comes into contact with the image forming units 51 for the respective colors aligned horizontally so that toner images of the respective colors are transferred thereto from the image forming units 51, primary transfer rollers 54 provided at positions opposite on the upper side to the image forming units 51 for the respective colors so as to hold the intermediate transfer belt 53 with the image forming units 51, a drive roller 55 that rotates the intermediate transfer belt 53, a driven roller 56 that rotates by the rotation of the drive roller 55 transmitted through the intermediate transfer belt 53, a secondary transfer roller 57 installed at a position opposite the drive roller 55 with the intermediate transfer belt 53 therebetween, and a cleaner 58 installed at a position opposite the driven roller 56 with the intermediate transfer belt 53 therebetween.

Each image forming unit 51 includes a photoconductor drum 61 in contact with the outer peripheral surface of the intermediate transfer belt 53, a charger 62 that charges the outer peripheral surface of the photoconductor drum 61 by corona discharge, a developer 63 that causes toner agitated and charged to adhere to the outer peripheral surface of the drum 61, and a cleaner 64 that removes toner remaining on the outer peripheral surface of the photoconductor drum 61 after a toner image is transferred to the intermediate transfer belt 53. At this time, the photoconductor drum 61 is installed at a position opposite the primary transfer roller 54 with the intermediate transfer belt 53 therebetween, and rotates in a clockwise direction in FIG. 2. Around the photoconductor drum 61, the primary transfer roller 54, the cleaner 64, the charger 62, and the developer 63 are sequentially disposed along the rotation direction of the photoconductor drum 61.

The intermediate transfer belt 53 is formed, for example, by an endless belt member having conductivity. The intermediate transfer belt 53 is wound on the drive roller 55 and the driven roller 56 without slack so as to rotate in a counterclockwise direction in FIG. 2 in accordance with the rotation of the drive roller 55. Around the intermediate transfer belt 53, the secondary transfer roller 57, the cleaner 58, and the image forming units 51 for the YMCK colors are sequentially disposed along the rotation direction of the intermediate transfer belt 53.

The fuser 6 fuses a toner image transferred to the recording paper P2 The fuser 6 includes a heating roller 59 with a halogen lamp or the like that heats a toner image on the recording paper P2 for fusing, and a pressure roller 60 that holds the recording paper P2 with the heating roller 59 and pressurizes the recording paper P2. For the heating roller 59, eddy currents may be generated in its surface by electromagnetic induction so that the surface of the heating roller 59 is heated.

In the image forming apparatus 1, each of the paper cassettes 4A to 4D is connected to a paper feed path R1. A transport device that transports the recording paper P2 includes a feed roller 81 that feeds the recording paper P2 stored in each of the paper cassettes 4A to 4D from the top layer to the paper feed path R1, a pair of paper feed rollers 82 that further feeds the fed recording paper P2 to the paper feed path R1, a pair of transport rollers 83 that vertically transports the recording paper P2 fed by the pair of paper feed rollers 82 along a main transport path R0, and a skew correction roller 84 that is disposed downstream of the pair of transport rollers 83 in the main transport path R0 to transport the recording paper P2 to the transfer section 5. Each of the paper cassettes 4A to 4D is provided with a paper feed sensor 80 for detecting the recording paper P2 fed from the paper cassette.

The main transport path R0 is a main transport path of the recording paper P2 in an image formation (printing) process. The paper feed path R1 is provided for each of the paper cassettes 4A to 4D. Each paper feed path R1 joins the main transport path R0. Each paper feed path R1 is an example of a transport path.

The recording paper P2 in each of the paper cassettes 4A to 4D is sent off to the paper feed path R1 one by one from the top layer by the rotational drive of the feed roller 81 for each of the paper cassettes 4A to 4D, and then sent off to the main transport path R0 by the pair of paper feed rollers 82. The paper feed sensor 80 detects the recording paper P2 sent off to the paper feed path R1 from each of the paper cassettes 4A to 4D.

The image forming apparatus 1 further includes a manual feed tray 4X. In the image forming apparatus 1, the transport device can also send recording paper P2 placed on the manual feed tray 4X to the main transport path R0 as well as the recording paper P2 placed on the paper cassettes 4A to 4D.

In the main transport path R0, the recording paper P2 transported from the pair of paper feed rollers 82 is transported to the skew correction roller 84 disposed in front of the transfer section 5 by the rotational drive of the pair of transport rollers 83. The skew correction roller 84 transports the recording paper P2. to the transfer section 5 in synchronization with toner image formation timing at the transfer section 5 so that a toner image is properly transferred to the recording paper P2 by the transfer section 5. That is, when the recording paper is transported to the skew correction roller 84 by the pair of transport rollers 83, the skew correction roller 84 is stopped so that the recording paper P2 slackens, forming a loop. Paper skew is corrected by the loop, and then the recording paper P2 is transported to the secondary transfer roller 57.

In the main transport path R0, a transport sensor (recording paper detector) 85 that detects the recording paper P2 vertically transported by the pair of transport rollers 83 is installed above the pair of transport rollers 83 (downstream in the transport direction). The skew correction roller 84 is an example of a registration roller.

A sensor unit 500 is provided below the skew correction roller 84 (upstream in the transport direction). The sensor unit 500 includes a sensor as described later, In the image forming apparatus 1, the type of the recording paper P2 can be detected based on a signal from the sensor of the sensor unit 500. Based on the result of detection of the type of the recording paper P2, the image forming apparatus 1 sets process control conditions (such as the transport speed of the recording paper P2) for image formation on the recording paper P2.

Based on the signal from the sensor unit 500, the image forming apparatus 1 detects the front end of the recording paper P2 that has reached the front of the skew correction roller 84, and can perform paper transport and loop control in the main transport path R0, based on the timing when the recording paper P2 reaches the skew correction roller 84 from the sensor unit 500.

A pair of paper ejection rollers 91 that ejects the printed recording paper P2 is disposed at a terminal portion that is the downstream end of the main transport path R0. The printed recording paper P2 is ejected to the paper output tray 7 by the rotational drive of the pair of paper ejection rollers 91. In the main transport path R0, a paper ejection sensor 90 that detects the rear end of the recording paper P2 is disposed below the pair of paper ejection rollers 91 (upstream in the transport direction). Thus, by the paper ejection sensor 90 detecting the rear end of the recording paper P2, it can be checked that the recording paper P2 has been normally ejected from the pair of paper ejection rollers 91 to the paper output tray 7,

### 2. Hardware Configuration of Image Forming Apparatus

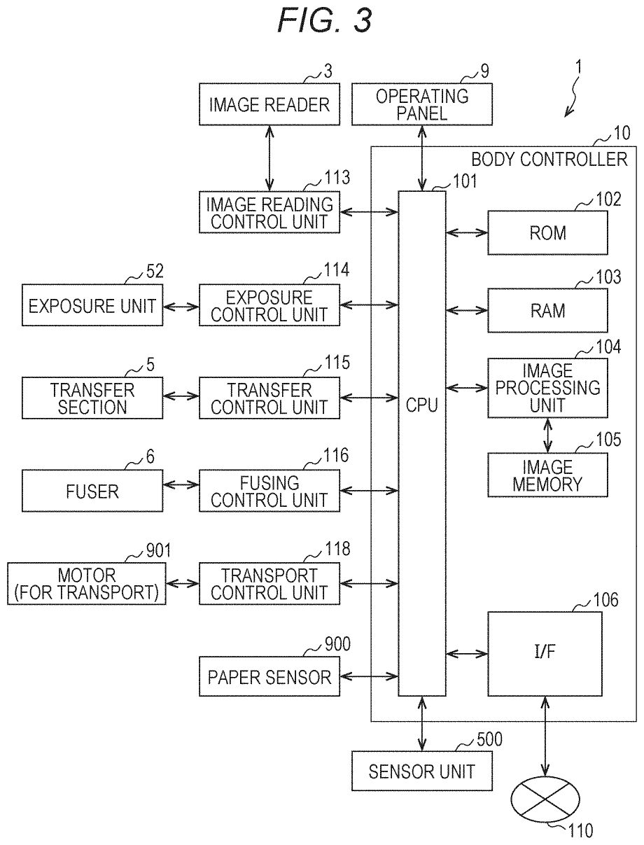

FIG. 3 is a diagram showing a hardware configuration of the image forming apparatus 1. The image forming apparatus 1 includes a body controller 10 of a configuration shown in FIG. 3. The body controller 10 controls parts constituting the image forming apparatus 1. Thus, various operations in the image forming apparatus 1 (an operation of printing on the recording paper P2, an operation of image reading from the original P1, etc.) are performed.

The body controller 10 includes a central processing unit (CPU) 101 that executes various types of arithmetic processing and control, read-only memory (ROM) 102 that stores control programs and others, random-access memory (RAM) 103 that temporarily stores arithmetic data, an image processing unit 104 that generates image data that is a basis for a toner image formed by the transfer section 5, an image memory 105 that temporarily stores image data obtained by the image processing unit 104, and an input-output interface 106 that transmits and receives signals to and from the parts constituting the image forming apparatus 1.

When receiving a signal corresponding to an operation accepted by the operating panel 9, the CPU 101 identifies an operation corresponding to the operation accepted by the operating panel 9. Likewise, when the body controller 10 receives, through the input-output interface 106, a signal transmitted from an external terminal or the like via a communication network 110 such as a local-area network (LAN), it identifies an operation specified by the external terminal. Consequently, the CPU 101 reads a control program from the ROM 102 based on the operation specified via the operating panel 9 or the external terminal, and the CPU 101 operates based on the control program.

Based on the control program read from the ROM 102, the CPU 101 outputs signals to an image reading control unit 113, an exposure control unit 114, a transfer control unit 115, a fusing control unit 116, and a transport control unit 118 that control the drive of the image reader 3, the exposure unit 52, the transfer section 5, the fuser 6, and a paper feeder 8, respectively. Thus, by the signals being provided from the body controller 10 to the image reading control unit 113, the exposure control unit 114, the transfer control unit 115, and the fusing control unit 116, the image forming apparatus 1 drives the image reader 3, the exposure unit 52, the transfer section 5, and the fuser 6 according to the specified operation. By the signal being provided from the body controller 10 to the transport control unit 118, the image forming apparatus 1 rotationally drives the feed roller 81, the pairs of rollers 82, 83, and 91, and the skew correction roller 84 in the transport device. A motor 901 is a motor for driving the various rollers for recording paper transport in the image forming apparatus 1. The drive of the various rollers can be performed by the CPU 101 controlling the operation of the motor 901 via the transport control unit 118.

The sensor unit 500 is connected to the CPU 101, The CPU 101 controls the operation of the sensor unit 500, and detects the type of the recording paper P2 based on a signal from the sensor unit 500.

### 3. Printing Operation of Image Forming Apparatus

Next, a printing operation by the image forming apparatus 1 will be described below. When the image forming apparatus 1 receives an instruction to perform the printing operation through the operating panel 9 or the external terminal, the CPU 101 in the body controller 10 reads a control program for the printing operation from the ROM 102 and starts a control operation for the printing operation. First, the CPU 101 controls the drive of the transport device through the transport control unit 118 to feed the recording paper P2 in the top layer from the paper cassette 4 and send it off to the main transport path R0.

The CPU 101 provides control signals to the exposure control unit 114 and the transfer control unit 115 to control the drive of the exposure unit 52 and the transfer section 5 in order to transfer a toner image to the recording paper P2 sent off to the main transport path R0. At this time, the CPU 101 provides, to the image processing unit 103, an image signal read from the original P1 by the image reader 3 through the image reading control unit 113 or an image signal received from the external terminal through the input-output interface 106.

Consequently, the image processing unit 103 generates image data for forming toner images of the Y, M, C, and K colors based on the provided image signal, and stores the image data in the image memory 105. The image data of the Y, M, C, and K colors stored in the image memory 105 is read by the CPU 101 and provided to the exposure control unit 114. Consequently, the exposure control unit 114 drives light-emitting elements (not shown) in the exposure unit 52 based on the image data of the Y, M, C, and K colors, forming electrostatic latent images on the photoconductor drums 61 for the Y, M, C, and K colors. That is, the transfer control unit 115 drives the transfer section 5, so that in the image forming units 51 for the Y, M, C, and K colors, the surfaces of the photoconductor drums 61 charged by the chargers 62 are radiated with laser light from the exposure unit 52 to form electrostatic latent images corresponding to the images of the Y. M, C, and K colors.

Toner charged at the developers 63 moves to the surfaces of the photoconductor drums 61 on which the electrostatic latent images have been formed, forming toner images on the photoconductor drums 61 serving as first image carriers. When the toner images carried on the surfaces of the photoconductor drums 61 come into contact with the intermediate transfer belt 53, they are transferred to the intermediate transfer belt 53 by electrostatic force of the primary transfer rollers 54, so that a toner image of the Y, M, C, and K colors superimposed on top of one another is formed on the surface of the intermediate transfer belt 53 serving as a second image carrier. On the other hand, untransferred toner remaining on the photoconductor drums 61 from which the toner images have been transferred to the intermediate transfer belt 53 is scraped off by the cleaners 64 and removed from the surfaces of the photoconductor drums 61.

When the front end of the recording paper P2 transported to the main transport path R0 is detected based on a signal from the sensor unit 500, the detection result is provided to the transfer control unit 115. Consequently, the transfer control unit 115 recognizes that the recording paper P2 has reached the skew correction roller 84. The transfer control unit 115 operates the skew correction roller 84 according to the timing when a toner image is transferred to the intermediate transfer belt 53. At this time, the toner image transferred to the intermediate transfer belt 53 moves to a transfer position where it conies into contact with the secondary transfer roller 57 by the intermediate transfer belt 53 being rotated by the drive roller 55 and the driven roller 56, and is transferred to the recording paper P2 transported to the transfer position on the main transport path R0. Untransferred toner remaining on the intermediate transfer belt 53 from which the toner image has been transferred to the recording paper P2 is scraped off by the cleaner 58 and removed from the surface of the intermediate transfer belt 53.

The recording paper P2 to which the toner image has been transferred at the position of contact with the secondary transfer roller 57 is transported to the fuser 6 with the heating roller 59 and the pressure roller 60. At this time, the CPU 101 controls the drive of the fuser 6 through the fusing control unit 116 in order to fuse the toner image on the recording paper P2 transported to the fuser 6 (STEP 123). That is, the fusing control unit 116 controls the rotational operation of the heating roller 59 and the pressure roller 60, and at the same time controls a heating operation of the heating roller 59.

Consequently, the recording paper P2 carrying the unfused toner image is subjected to heating by the heating roller 59 and pressurization by the pressure roller 60 when passing through a fusing nip of the fuser 6, so that the unfused toner image is fused to the surface of the paper. When the recording paper P2 after the toner image fusing (after single-sided printing) is transported to the pair of paper ejection rollers 91, it is ejected to the paper output tray 7 by the pair of paper ejection rollers 91. At this time, the paper ejection sensor 90 detects the rear end of the recording paper P2, and the detection result is provided to the body controller 10. Consequently, the body controller 10 checks that the recording paper P2 has been normally ejected to the paper output tray 7.

### 4. Configuration of Sensor Unit 500

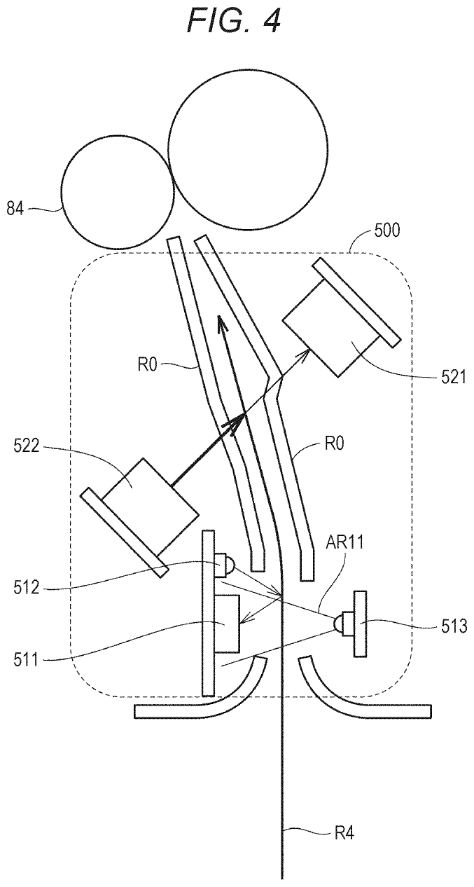

FIG. 4 is a diagram for explaining a configuration of the sensor unit 500. In FIG. 4, an arrow R4 indicates the transport direction of the recording paper P2 on the main transport path R0. The sensor unit 500 includes an optical detector that outputs a signal based on optical detection, and an ultrasonic detector that outputs a signal based on detection using ultrasonic waves.

### Optical Detector

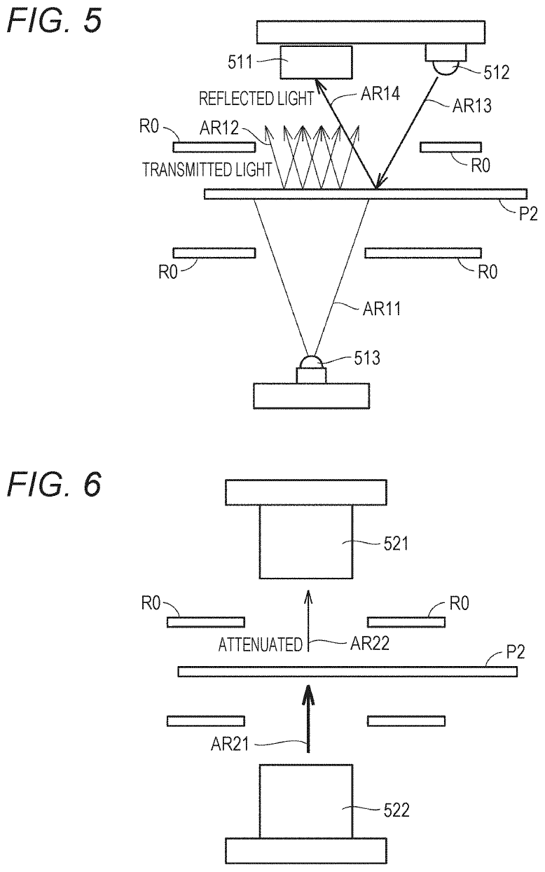

FIG. 5 is an enlarged view of the optical detector in the sensor unit 500. The optical detector includes a light receiver 511 and light sources 512 and 513. The light receiver 511 includes, for example, a charge-coupled device (CCD) sensor. The light sources 512 and 513 include, for example, light-emitting diode (LED) elements.

The light source 512 is disposed on the same side as the light receiver 511 with reference to the main transport path R0. In FIG. 5, an arrow AR13 indicates light emitted by the light source 512, and an arrow AR14 indicates light reflected off the surface of the recording paper P2 and traveling to the light receiver 511, of the light indicated as the arrow AR13. The light receiver 511 detects the light output from the light source 512 and reflected off the recording paper P2 on the main transport path R0.

The light source 513 is disposed opposite the light receiver 511 with reference to the main transport path R0. In FIG. 5, an area AR11 indicates light emitted by the light source 513, and arrows AR12 indicate light passing through the recording paper P2 and traveling to the light receiver 511, of the light indicated as the area AR11. The light receiver 511 detects the light output from the light source 513 and reaching the light receiver 511 through the main transport path R0. When the recording paper P2 is present between the light receiver 511 and the light source 513, the light receiver 511 detects light output from the light source 513 and transmitted through the recording paper P2.

The light receiver 511 outputs to the CPU 101 a signal indicating the result of detection of light from the light source 512 and/or the light source 513 (a signal according to the amount of light received by the light receiver 511). Based on the signal from the light receiver 511. the CPU 101 determines the timing when the front end of the recording paper P2 has reached the inside of the sensor unit 500, detects the basis weight of the recording paper P2 in the sensor unit 500, and detects that the recording paper P2 in the sensor unit 500 is a sheet of a specific type (for example, an overhead projector (OHP) transparency sheet).

In the present specification, an operation to detect the front end of the recording paper P2 by the optical detector is referred to as a “first operation”, and an operation to detect the basis weight of the recording paper P2 and/or to detect that the recording paper P2 is a sheet of a specific type is referred to as a “second operation”.

### Ultrasonic Detector

FIG. 6 is an enlarged view of the ultrasonic detector in the sensor unit 500. The ultrasonic detector includes a transmitter 522 that transmits ultrasonic waves. The ultrasonic detector further includes a receiver 521 that receives the ultrasonic waves and outputs a signal corresponding to the intensity of the received ultrasonic waves.

In FIG. 6, an arrow AR21 indicates ultrasonic waves output from the transmitter 522. An arrow AR22 indicates the ultrasonic waves indicated by the arrow AR21 after being attenuated by the recording paper P2. The receiver 521 detects the ultrasonic waves output from the transmitter 522, When the recording paper P2 is present between the receiver 521 and the transmitter 522, the receiver 521 detects ultrasonic waves transmitted by the transmitter 522 and then attenuated by the recording paper P2.

The receiver 521 outputs a signal according to the intensity of the detected ultrasonic waves to the CPU 101. Based on the signal from the receiver 521, the CPU 101 detects that the front end of the recording paper P2 is present between the receiver 521 and the transmitter 522, and also detects the type of the recording paper P2 (an envelope, recording paper with two or more sheets placed on top of another, or the like).

In the present specification, an operation to detect the front end of the recording paper P2 by the ultrasonic detector is referred to as a “first operation”, and an operation to detect the basis weight of the recording paper P2 and/or to detect that the recording paper P2 is a sheet of a specific type is referred to as a “second operation”.

That is, in the present specification, each of the optical detector and the ultrasonic detector can perform the “first operation” and the “second operation”.

The image forming apparatus 1 may include both the optical detector and the ultrasonic detector as shown in FIG. 4 and other drawings, or may include only one of them.

In FIG. 4, the optical detector is provided upstream of the ultrasonic detector in the transport path of the recording paper P2. The ultrasonic detector may be provided upstream of the optical detector.

The CPU 101 may detect the front end of the recording paper P2 in the sensor unit 500 using one of the optical detector and the ultrasonic detector, and detect the type of the recording paper P2 using the other. In this case, the CPU 101 may detect the front end of the recording paper P2 using the downstream detector, and detect the type of the recording paper P2 using the upstream detector in response to the detection of the front end of the recording paper P2.

### 5. Functional Configuration of Image Forming Apparatus

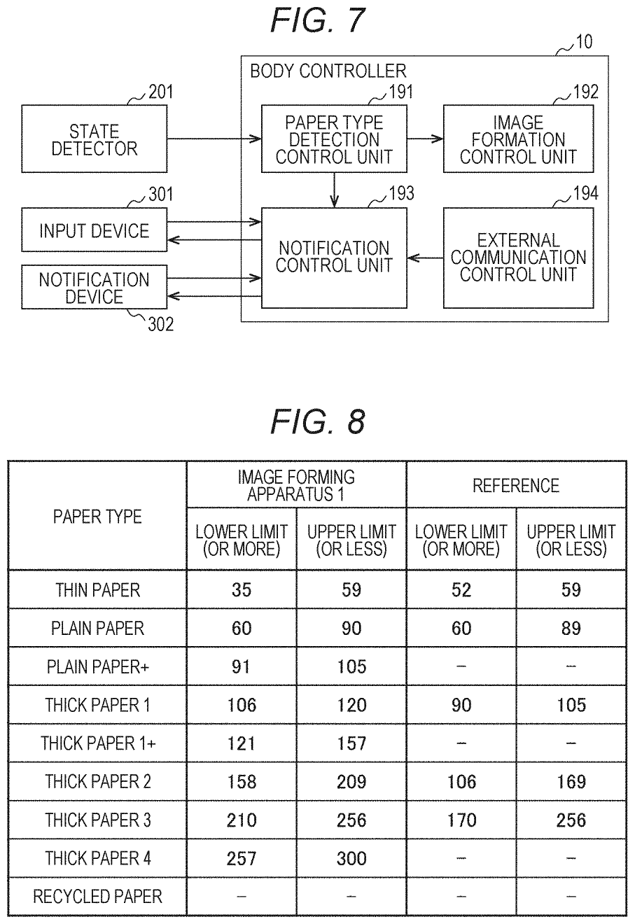

FIG. 7 is a diagram showing a functional configuration of the image forming apparatus 1.

As shown in FIG. 7, in one implementation example, by the CPU 101 executing a given program, the body controller 10 of the image forming apparatus 1 functions as a paper type detection control unit 191, an image formation control unit 192, a notification control unit 193, and an external communication control unit 194. The image forming apparatus 1 functions as a state detector 201, an input device 301, and a notification device 302.

The state detector 201 acquires data for detecting the type of the recording paper P2 transported by the transport device, and outputs it to the paper type detection control unit 191. In one implementation example, the state detector 201 is implemented by the sensor unit 500.

The input device 301 accepts inputs of information to the notification control unit 193. The input device 301 may be touch sensors and/or hardware buttons on the operating panel 9 that accept inputs of information from the user, or may be the input-output interface 106 that accepts inputs of information from an external device, or may be both of them.

The notification device 302 outputs information to be notified to the outside. The notification device 302 may be a display on the operating panel 9, a speaker (not shown), or both of them.

The functions of the body controller 10 will be described below.

The paper type detection control unit 191 detects the type of the recording paper P2 (hereinafter, also referred to as the “paper type”), using a signal from the state detector 201. Types detected will be described later with reference to FIG. 8 and other drawings.

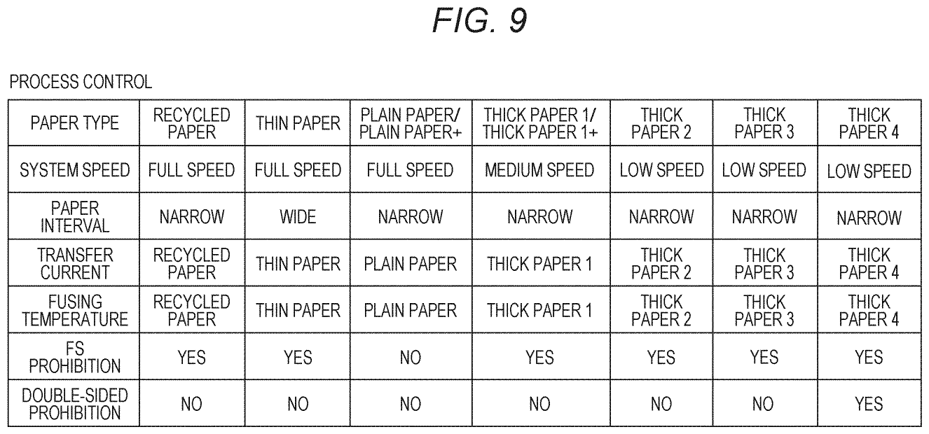

The image formation control unit 192 controls the operations of parts driven to form an image on the recording paper P2 in the image forming apparatus 1. These parts include, for example, the image reader 3, the transfer section 5, the fuser 6, and the transport device. The image formation control unit 192 controls the operations of the above-mentioned parts according to the result of detection of the type by the paper type detection control unit 191. The details of the control will be described later with reference to FIG. 9 and other drawings.

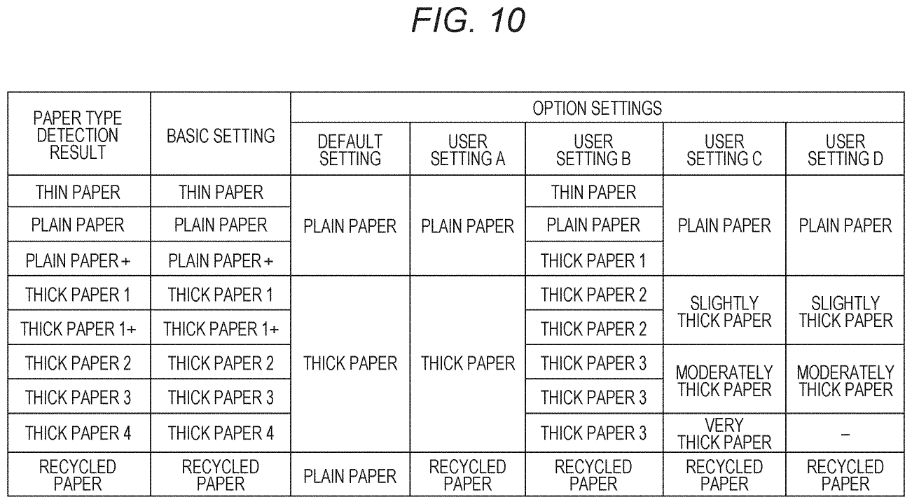

The notification control unit 193 controls notification information of the type of the recording paper P2 at the notification device 302 according to the result of detection of the type by the paper type detection control unit 191. The notification information will be described later with reference to FIG. 10 and other drawings.

The external communication control unit 194 acquires inputs of information (for example, image formation settings such as a “color setting” and a “magnification setting”) from the external device, and transfers them to the notification control unit 193. The notification control unit 193 further uses the information acquired from the external communication control unit 194 to control notification information at the notification device 302.

### 6. Examples of Detection of Recording Paper Type

FIG. 8 is a diagram showing an example of a correspondence relationship between a signal from the sensor unit 500 and the result of detection of the type of the recording paper P2 in the image forming apparatus 1. The CPU 101 detects the type of the recording paper P2, based on a signal from the sensor unit 500 and the correspondence relationship. In addition to the correspondence relationship in the “image forming apparatus 1”, FIG. 8 shows a correspondence relationship in another apparatus as a “reference”.

In the leftmost column of FIG. 8, detection results are listed as the “paper type”. The detection results include thin paper, plain paper, plain paper+, thick paper 1, thick paper 1+, thick paper 2, thick paper 3, thick paper 4, and recycled paper.

FIG. 8 includes a lower limit and an upper limit of a numerical value representing the basis weight (unit: g/m²) of the recording paper P2 determined based on a signal from the sensor unit 500. For example, in the image forming apparatus 1, on the type “plain paper”, the lower limit is “60” and the upper limit is “90”. That is, if the basis weight is 60 g/m² or more and 90 g/m² or less, the type of the recording paper P2 is the “plain paper”.

On the other hand, on the type “plain paper” in the apparatus indicated as the “reference”, the lower limit is “60” and the upper limit is “89”. In this apparatus, if the basis weight is 60 g/m² or more and 89 g/m² or less, the type of recording paper is the “plain paper”. That is, different detection results can be derived on the same paper in different apparatuses.

The correspondence relationship in the “image forming apparatus 1” is stored in a storage device such as the ROM 102 accessible to the CPU 101.

### 7. Process Control

FIG. 9 is a diagram for explaining the details of process control according to the type of the recording paper P2 in the image forming apparatus 1.

In the top row of FIG. 9, the detectable types of the recording paper P2 (recycled paper, thin paper, plain paper, plain paper+, thick paper 1, thick paper 1+, thick paper 2, thick paper 3. and thick paper 4) are shown.

In the leftmost column of FIG. 9, control items (system speed, paper interval, transfer current, fusing temperature, FS prohibition, and double-sided prohibition) are shown.

The system speed indicates speed at which the recording paper P2 is transported. As the system speed, one of “full speed”, “medium speed”, and “low speed” is set. The “full speed” represents the highest system speed, the “medium speed” represents the next highest system speed, and the “low speed” represents the lowest system speed.

The paper interval indicates an interval at which the recording paper P2 is transported. As the paper interval, “wide” or “narrow” is set.

The transfer current indicates a current value supplied to the photoconductor drums 61 for transfer. As shown in FIG. 9, current values corresponding to the types of the recording paper P2 are set. For example, if the type of recording paper is the “plain paper” or the “plain paper+”, a current value for the “plain paper” is set.

The fusing temperature indicates the heating temperature of the heating roller 59 of the fuser 6. As shown in FIG. 9, temperatures corresponding to the types of the recording paper P2 are set. For example, if the type of recording paper is the “plain paper” or the “plain paper+”, a temperature for the “plain paper” is set.

The FS prohibition indicates whether or not there is a limitation on post-processing (stapling, punching, etc.) by a finisher (post-processing device). “Yes” indicates that content related to the post-processing is changed for a print job according to a predetermined limitation. An example of the predetermined limitation is the number of sheets that can be stapled set for each type of recording paper. In this case, if the value of the FS prohibition is “Yes” and a prim job specifies stapling on a number of sheets of recording paper that exceeds the number of sheets that can be stapled, the print job is changed so that the number of sheets to be stapled at a time becomes smaller than or equal to the number of sheets that can be stapled. On the other hand, “No” indicates that there is no limitation on the post-processing, and means that no change is made to the content related to the post-processing for a print job.

The double-sided prohibition indicates whether or not there is a prohibition on double-sided printing. “Yes” indicates that a print job is changed so that double-sided printing is not performed even if the print job includes a double-sided printing instruction. “No” means that no change is made to a print job.

Information shown in FIG. 9 is stored in a storage device such as the ROM 102 accessible to the CPU 101.

### 8. Display Setting Information

FIG. 10 is a diagram for explaining a correspondence relationship between the result of detection of the type of the recording paper P2 and the display information of the type by the notification device 302.

The leftmost column of FIG. 10 shows the result of detection of the type of the recording paper P2. The detection results include thin paper, plain paper, plain paper, thick paper 1, thick paper 1+, thick paper 2, thick paper 3, thick paper 4, and recycled paper.

FIG. 10 shows a basic setting and option settings. In the basic setting, a type according to the detection result is displayed as the type of the recording paper P2. That is, the type displayed in the basic setting is the same as the type of the detection result. Thus, in the basic setting, the number of types included in the detection results is equal to the number of types that can be displayed.

On the other hand, in the option settings, a type that is the detection result is displayed in a mode including a change as the type of the recording paper P2. In the option settings, the number of types that can be displayed is fewer than the number of types included in the detection results. In FIG. 10, five types of settings (a default setting, a user setting A, a user setting B, a user setting C, and a user setting D) are included as the option settings.

For example, in the “default setting”, if the detection result is the “thin paper”, the “plain paper” or the “plain paper+”, “plain paper” is displayed as the type of the recording paper P2. That is, if the detection result is the “plain paper”, the same type as the type of the detection result is displayed, but if the detection result is the “thin paper”, the type “plain paper” is displayed as a result of a change made to the type of the detection result.

In the “default setting”, if the detection result is the “thick paper 1”, the “thick paper 1+”, the “thick paper 2”, the “thick paper 3”, or the “thick paper 4”, the type “thick paper” is displayed as a result of a change made to the detection result. The detection results “thick paper 1”, “thick paper 1+”, “thick paper 2”, “thick paper 3”, and “thick paper 4” all indicate classifications in the “thick paper”. That is, if the detection result is the “thick paper 1”, the “thick paper 1+”, the “thick paper 2”, the “thick paper 3”, or the “thick paper 4”, the “thick paper” that is a general term for these detection results is displayed.

In the “default setting”, if the detection result is the “recycled paper”, “plain paper” is displayed as the type of the recording paper P2. That is, if the detection result is the “recycled paper”, the type “plain paper” is displayed as a result of a change made to the type of the detection result.

In the “user setting D”, it is specified that the type of the recording paper P2 is not displayed for a certain detection result. More specifically, in FIG. 10, the value of the detection result “thick paper 4” in the “user setting D” is “−”. This means that in the “user setting D”, if the detection result is the “thick paper 4”, the type of the recording paper P2 is not displayed.

Furthermore, in the “user setting D”, it is specified that names that are not included in the detection results are displayed for some detection results. More specifically, in FIG. 10, the value of the detection result “recycled paper” in the “user setting D” is “recycle paper”. This means that in the “user setting D”, if the detection result is the “recycled paper”, “recycle paper”, which is a name not included in the detection results, is displayed as the type of the recording paper P2.

The user can set a display pattern of the recording paper P2 using the input device 301. Furthermore, if the user selects a certain option setting (for example, the user setting D) using the input device 301, the user can set names to be displayed in correspondence with detection results (for example, character strings such as “recycle paper”). The notification control unit 193 updates display setting information using set names.

The information shown in FIG. 10 and a setting input by the user are stored in a storage device such as the ROM 102 accessible to the CPU 101.

### 9. Process Flow (1)

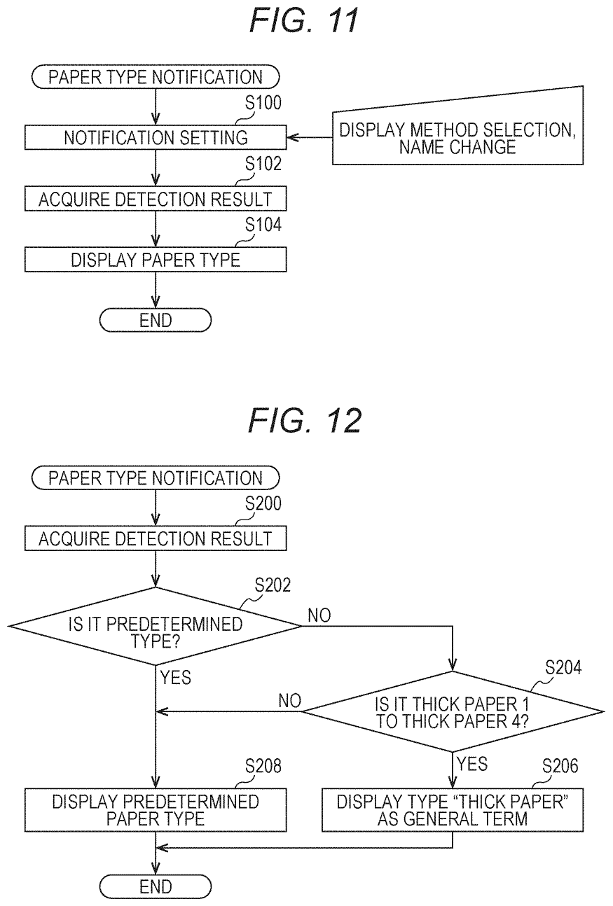

FIG. 11 is a flowchart of a first example of a process performed to display the type of the recording paper P2 in the image forming apparatus 1. The image forming apparatus 1 performs the process of FIG. 11 by the CPU 101 executing a given program, for example. The process of FIG. 11 is performed, for example, at the timing of displaying a screen including the type of the recording paper P2 in the image forming apparatus 1.

Referring to FIG. 11, in step S100, the CPU 101 acquires a setting related to notification. An example of information acquired about the setting is the selection of one of the basic setting, the default setting, the user setting A, the user setting B, the user setting C, and the user setting D shown in the display setting information of FIG. 10. Another example is the specification of a name (for example, “recycle paper”) to be displayed as the type of the recording paper P2 in the user setting A, the user setting B, the user setting C, or the user setting D.

In step S102, the CPU 101 acquires the result of detection of the type of the recording paper P2. The detection result is generated, for example, based on a signal from the sensor unit 500.

In step S104, the CPU 101 displays the type of the recording paper P2. based on the setting information acquired in step S100 and the detection result acquired in step S102.

For example, if the “basic setting” (FIG. 10) has been acquired as the setting information in step S100, the CPU 101 displays a type that is the detection result acquired in step S102 without making a change. If the “default setting” (FIG. 10) has been acquired as the setting information, the CPU 101 changes a type that is the detection result acquired in step S102 as necessary according to the correspondence relationship between the type of the detection result and the type to be displayed shown as the “default setting” in FIG. 10, and then displays the type.

After that, the CPU 101 finishes the control FIG. 11.

### 10. Processing Flow (2)

FIG. 12 is a flowchart of a second example of a process performed to display the type of the recording paper P2 in the image forming apparatus 1. The image forming apparatus 1 performs the process of FIG. 12 by the CPU 101 executing a given program, for example. The process of FIG. 12 is performed, for example, at the tuning of displaying a screen including the type of the recording paper P2 in the image forming apparatus 1. The user can set a first display pattern or a second display pattern as a display pattern of the recording paper P2, using the input device 301. In the first display pattern, the number of types included in the detection results is equal to the number of types that can be displayed. In the second display pattern, the number of types that can be displayed is fewer than the number of types included in the detection results. The process of FIG. 12 is performed on condition that the second display pattern is set. The process of FIG. 11 refers to the display setting information (FIG. 10), whereas the process of FIG. 12 does not require reference to the display setting information (FIG. 10).

Referring to FIG. 12, in step S200, the CPU 101 acquires the result of detection of the type of the recording paper P2 as in step S102.

in step S202, the CPU 101 determines whether or not the detection result acquired in step S202 is a predetermined type (for example, the plain paper). Information specifying “predetermined types” is preset and stored in a given memory. If the CPU 101 determines that the detection result is a predetermined type (YES in step S202), the control proceeds to step S208, and if not (NO in step S202), the control proceeds to step S204.

In step S204, the CPU 101 determines whether the detection result acquired in step S202 is the “thick paper 1”, the “thick paper 1+”, the “thick paper 2”, the “thick paper 3”, or the “thick paper 4”. If the CPU 101 determines that the detection result is the “thick paper 1”, the “thick paper 1+”, the “thick paper 2”, the “thick paper 3”, or the “thick paper 4” (YES in step S204), the control proceeds to step S206, and if not (NO in step S204), the control proceeds to step S208.

In step S206, the CPU 101 displays the “thick paper”, which is a general term for the “thick paper 1”, the “thick paper 1+”, the “thick paper 2”, the “thick paper 3”, or the “thick paper 4”, as the type of the recording paper P2. After that, the CPU 101 finishes the control in FIG. 12.

In step S208, the CPU 101 displays the name of the predetermined type (for example, the “plain paper”) as the type of the recording paper P2. After that, the CPU 101 finishes the control in FIG. 12.

According to the process of FIG. 12, if the detection result is the “thick paper 1”, the “thick paper 1+”, the “thick paper 2”, the “thick paper 3”, or the “thick paper 4”, the “thick paper” is displayed as the type of the recording paper P2, and if the detection result is other than these, the predetermined type (for example. the “plain paper”) is displayed as the type of the recording paper P2.

### 11. Specific Examples of Display

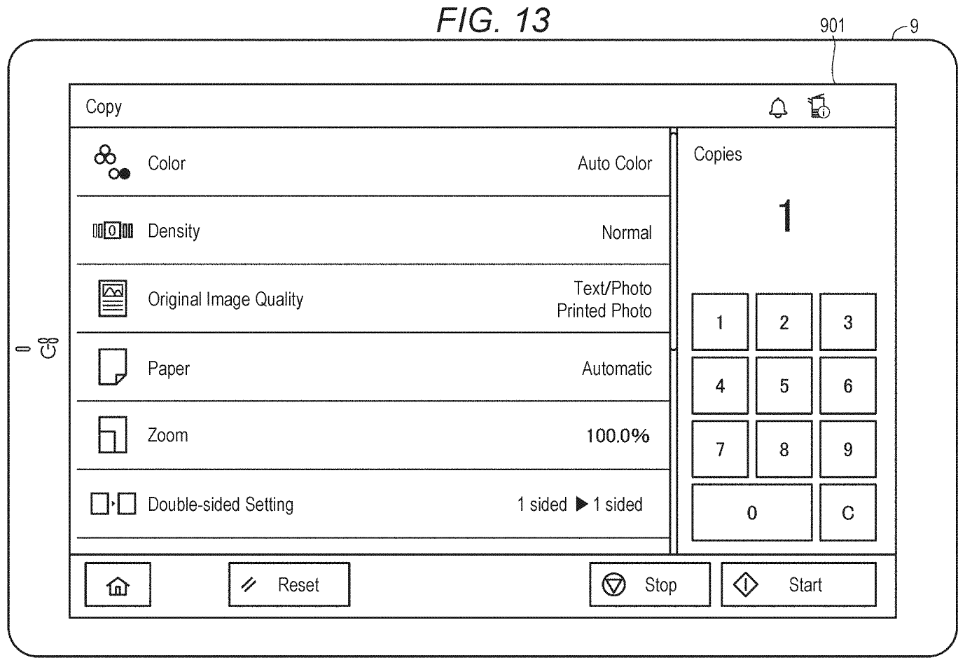

FIGS. 13 to 17 are diagrams showing specific examples of display information on the operating panel 9.

A screen 901 of FIG. 13 represents a basic screen. On the basic screen, default settings for the copy operation in the image forming apparatus 1 are displayed. The character string “Automatic” in a “Paper” section indicates that paper is automatically selected according to the size of an original.

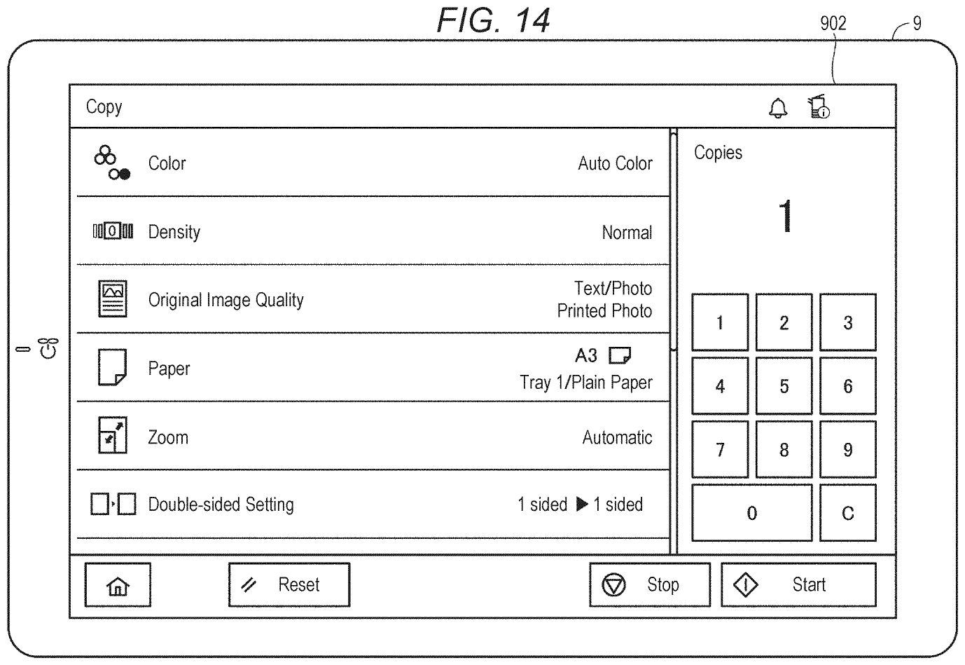

In the image forming apparatus 1, a paper cassette used for the copy operation can be selected. In the “Paper” section, information (the size and/or type) of recording paper stored in a selected paper cassette can be displayed (for example, see FIG. 14 described later). If a change of recording paper stored in each paper cassette is detected, the display of the recording paper information on the paper cassette is reset. An example of detection of a paper change is the detection of removal of a paper cassette from the apparatus body 2 and subsequent installment to the apparatus body 2, using a sensor. By the reset of the display, “Automatic” is displayed in the “Paper” section as shown in FIG. 13. After the change, recording paper in a selected paper cassette is transported so that the type of the recording paper is detected. The detected type is displayed according to the process described with reference to FIG. 11 or 12. The display of information on recording paper described above includes the display of the type of recording paper according to FIG. 11 or 12.

A screen 902 of FIG. 14 shows a state in which a paper cassette used for the copy operation of the image forming apparatus 1 is selected. More specifically, the character string “A3_Tray 1_Plain Paper” in the “Paper” section indicates that the size of the recording paper P2 stored in the paper cassette specified as a tray 1 (for example, the paper cassette 4A) is “A3”, and the type is the “plain paper”.

The type of the recording paper P2 on the screen 902 and others is the “type” of the recording paper P2 displayed by the process described with reference to FIG. 11 or 12.

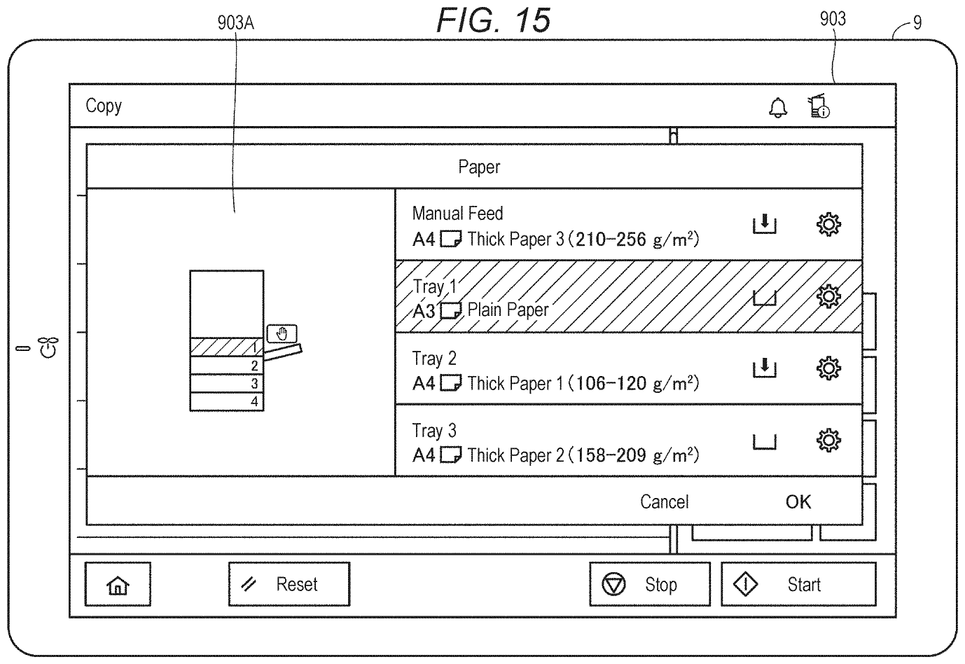

A screen 903 of FIG. 15 shows a screen for selecting a paper source (a manual feed tray or a paper cassette) in the copy operation. On the screen 903, the sizes and types of the recording paper P2 stored in “Manual Feed” (the manual feed tray 4X), “Tray 1” (the paper cassette 4A), “Tray 2” (the paper cassette 4B), and “Tray 3” (the paper cassette 4C) are displayed. On the screen 903, data on a selected paper source (Tray 1) is displayed in reverse video.

The screen 903 includes an area 903A. In the area 903A, an icon schematically showing the image forming apparatus 1 is displayed. In the icon, the position of the selected paper source is displayed in reverse video. The reverse video display is an example of information on a member storing paper.

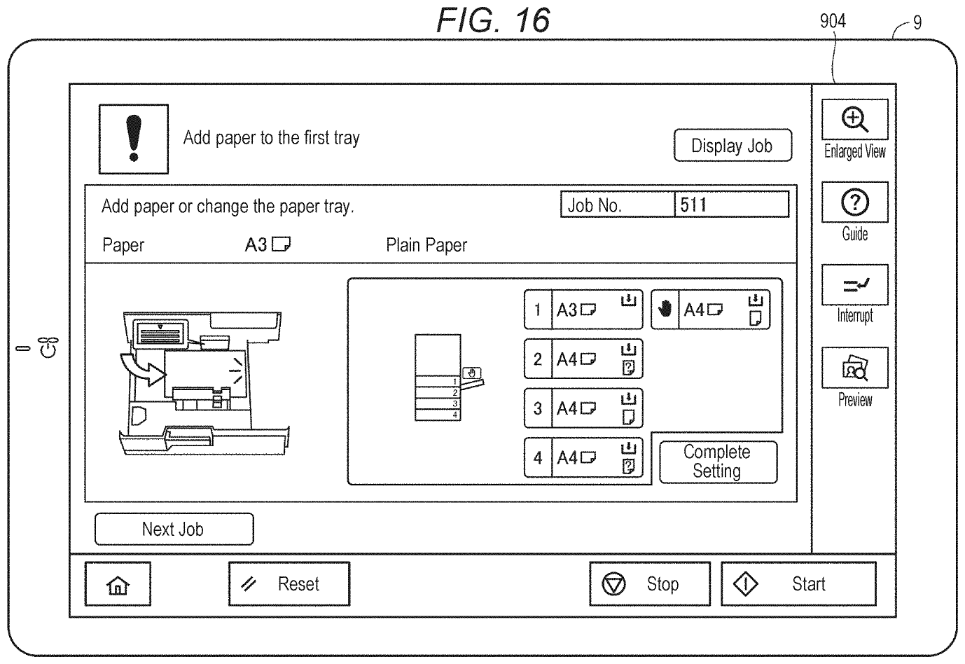

A screen 904 of FIG. 16 is displayed when recording paper has run out in a selected paper source. Each paper cassette and the paper output tray may be provided with a sensor that detects the presence or absence of recording paper on them. The CPU 101 may display the screen 904 based on the detection outputs of the sensors. On the screen 904, “Paper_A3_Plain Paper” is displayed together with the message “Add paper or change the paper tray”. The “Plain Paper” may be a type displayed about recording paper stored in the corresponding paper source until immediately before.

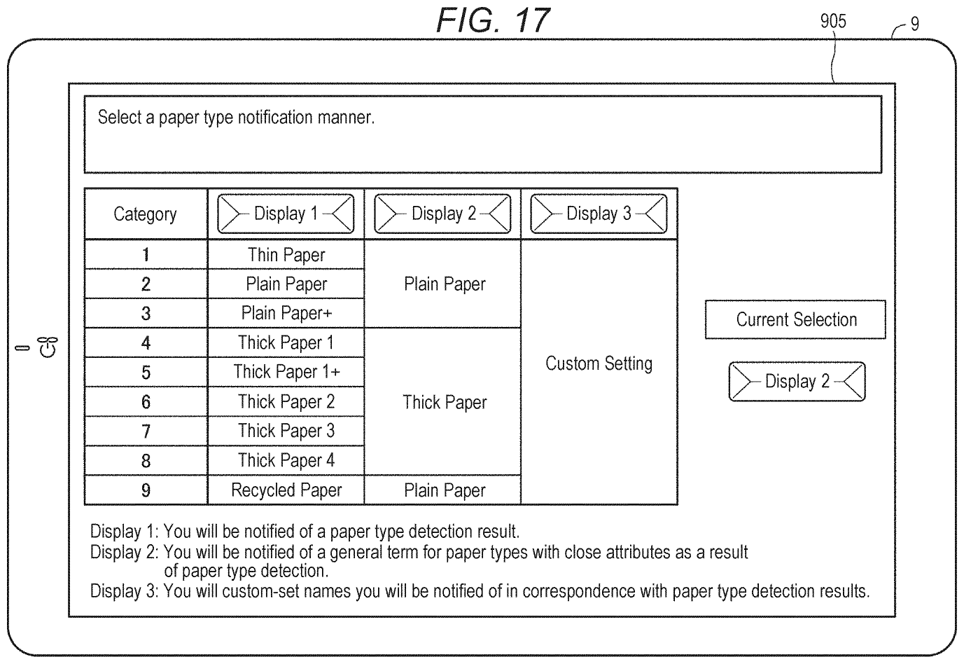

A screen 905 of FIG. 17 is a screen for entering a setting related to display information (a setting acquired in step S100). On the screen 905, categories 1 to 9 correspond to nine types of detection results, the thin paper, the plain paper, the plain paper+, the thick paper 1, the thick paper 1+, the thick paper 2, the thick paper 3, the thick paper 4, and the recycled paper, respectively. On the screen 905, three types of settings (a display 1, a display 2, and a display 3) can be entered. The “display 1” may correspond to the basic setting (FIG. 10).

On the screen 905, “Current Selection Display 2” represents display setting information registered at the present time. The user can select one of the display 1 to the display 3 on the screen 905. When the display 2 or the display 3 is selected, the user can enter a type (or a name) specifying the type of recording paper desired to be displayed for each of the categories 1 to 9.

Although embodiments of the present invention have been described and illustrated in detail, the disclosed embodiments are made for purposes of illustration and example only and not limitation. The scope of the present invention should be interpreted not by terms of the above descriptions but by terms of the appended claims, and is intended to include all alterations within meaning and scope equivalent to the scope of the claims. Further, inventions described in the embodiments and modifications are intended to be implemented alone or in combination as far as possible.

What is claimed is:

1. An image forming apparatus comprising:
a transport device that transports a sheet placed on a sheet holding member;
a detector that detects one type from among a first number of types as a type of the sheet transported by the transport device;
a display that displays the type of the sheet placed on the sheet holding member; and
an input device that accepts an instruction related to a display pattern of the type of the sheet,
wherein the input device accepts an instruction to select the display pattern from a first display pattern in which the type of the sheet placed on the sheet holding member is selected from among the first number of types, and a second display pattern in which the type of the sheet placed on the sheet holding member is selected from a second number of types fewer than the first number, and
the display displays the type that is a result of the detection by the detector according to the instruction accepted by the input device.

2. The image forming apparatus according to claim 1, further comprising:
an image forming device that forms an image on the sheet transported by the transport device,
the image forming device performing an operation to form an image according to the result of the detection by the detector.

3. The image forming apparatus according to claim 1, wherein in the second display pattern, the type that is the detection result is selected when the result of the detection by the detector is a first type, and a type other than the detection result is selected When the result of the detection by the detector is a second type.

4. The image forming apparatus according to claim 3, wherein the second type includes plain paper.

5. The image forming apparatus according to claim 3, wherein the first type includes at least one of thin paper and recycled paper.

6. The image forming apparatus according to claim 1, wherein in the second display pattern, a general term for the result of the detection by the detector is selected as the type of the sheet placed on the sheet holding member.

7. The image forming apparatus according to claim 1, wherein in the second display pattern, a type different from the result of the detection by the detector is selected as the type of the sheet placed on the sheet holding member, based on the type of the result of the detection by the detector.

8. The image forming apparatus according to claim 1, wherein the input device accepts an input of a type to be displayed by the display.

9. The image forming apparatus according to claim 1, wherein the display further displays at least one of information on the accepted instruction, information on the sheet holding member, and a state where no sheets are stored in the sheet holding member.

10. The image forming apparatus according to claim 1, wherein in the second display pattern, it is selected that the type of the sheet is not displayed when the result of the detection by the detector is a specific result.

11. The image forming apparatus according to claim 1, wherein the display and the input device are integrally formed.

12. A non-transitory recording medium storing a computer readable program executed by a computer, the program causing the computer to perform:
detecting one type from among a first number of types as a type of a sheet placed on a sheet holding member; and
displaying the type of the sheet placed on the sheet holding member,
wherein the displaying of the type of the sheet includes displaying the type of the sheet placed on the sheet holding member, according to a pattern selected from a first display pattern in which the type of the sheet placed on the sheet holding member is selected from among the first number of types, and a second display pattern in which the type of the sheet placed on the sheet holding member is selected from a second number of types fewer than the first number.
